(19) United States
(12) Patent Application Publication
(10) Pub. No.: US 2024/0276327 A1
(43) Pub. Date: Aug. 15, 2024

(54) BASE STATIONS AND CORE NETWORK DEVICE

(71) Applicant: GUANGDONG OPPO MOBILE TELECOMMUNICATIONS CORP., LTD., Dongguan (CN)

(72) Inventors: Fei LU, Dongguan (CN); Yali GUO, Dongguan (CN)

(21) Appl. No.: 18/646,117

(22) Filed: Apr. 25, 2024

Related U.S. Application Data
(63) Continuation of application No. PCT/CN2021/127684, filed on Oct. 29, 2021.

(51) Int. Cl. H04W 36/00; H04W 36/30; H04W 40/36; H04W 84/04; H04W 92/18

(52) U.S. Cl. CPC H04W 36/033; H04W 36/0061; H04W 36/304; H04W 40/36; H04W 84/042; H04W 92/18

(57) ABSTRACT

A first base station includes a transceiver, a memory configured to store a computer program, and a processor coupled to the transceiver and the memory. When executed by the processor, the computer program causes the first base station to send a handover request to a second base station according to an authorized public land mobile network (PLMN) list for the first terminal, where the second base station is a base station accessed by a second terminal, a PLMN identifier of a cell accessed by the second terminal is in the authorized PLMN list, and the handover request is used for requesting to switch a network access mode of the first terminal to accessing a network via a sidelink between the first terminal and the second terminal.

### CROSS-REFERENCE TO RELATED APPLICATION(S)

This application is a continuation of International Application No. PCT/CN2021/127684, filed Oct. 29, 2021, the entire disclosure of which is incorporated herein by reference.

### TECHNICAL FIELD

The disclosure relates to the technical field of wireless communication, and particularly to base stations and a core network device.

### BACKGROUND

Sidelink technology is a near-field communication technology in which terminals communicate directly through wireless interfaces between each other.

A relay sidelink scenario is introduced in the 5th Generation System (5GS). In the relay sidelink scenario, when a sidelink connection is established between two terminals, one terminal may serve as a relay through which the other terminal can access a network.

### SUMMARY

In one aspect, a base station is provided. The base station is a first base station accessed by a first terminal. The first base station includes a transceiver, a memory configured to store a computer program, and a processor coupled to the transceiver and the memory. When executed by the processor, the computer program causes the first base station to send a handover request to a second base station according to an authorized public land mobile network (PLMN) list for the first terminal, where the second base station is a base station accessed by a second terminal, a PLMN identifier of a cell accessed by the second terminal is in the authorized PLMN list, and the handover request is used for requesting to switch a network access mode of the first terminal to accessing a network via a sidelink between the first terminal and the second terminal.

In one aspect, a base station is provided. The base station is a second base station accessed by a second terminal. The second base station includes a transceiver, a memory configured to store a computer program, and a processor coupled to the transceiver and the memory. When executed by the processor, the computer program causes the second base station to receive a handover request sent by a first base station according to an authorized PLMN list for a first terminal, where the first base station is a base station accessed by the first terminal, a PLMN identifier of a cell accessed by the second terminal is in the authorized PLMN list, and the handover request is used for requesting to switch a network access mode of the first terminal to accessing a network via a sidelink between the first terminal and the second terminal.

In one aspect, a core network device is provided. The core network device includes a transceiver, a memory configured to store a computer program, and a processor coupled to the transceiver and the memory. When executed by the processor, the computer program causes the core network device to send an authorized PLMN list for a first terminal to a first base station, where the first base station is a base station accessed by the first terminal, the authorized PLMN list is a PLMN list used by the first base station to send a handover request to a second base station, the second base station is a base station accessed by a second terminal, a PLMN identifier of a cell accessed by the second terminal is in the authorized PLMN list, and the handover request is used for requesting to switch a network access mode of the first terminal to accessing a network via a sidelink between the first terminal and the second terminal.

### BRIEF DESCRIPTION OF THE DRAWINGS

The accompanying drawings herein, which are incorporated in and constitute a part of the specification, illustrate embodiments consistent with the disclosure, and together with the specification, are intended to explain the principles of the disclosure.

FIG. 1 is a schematic diagram of an implementation environment illustrated in an exemplary embodiment of the disclosure.

FIG. 2 is a diagram of a U2N relay system architecture illustrated in an exemplary embodiment of the disclosure.

FIG. 3 is a schematic flowchart of a relay UE discovery procedure illustrated in an exemplary embodiment of the disclosure.

FIG. 4 is a schematic flowchart of another relay UE discovery procedure illustrated in an exemplary embodiment of the disclosure.

FIG. 5 is a flowchart of a network access handover method illustrated according to an exemplary embodiment.

FIG. 6 is a flowchart of a network access handover method illustrated according to an exemplary embodiment.

FIG. 7 is a flowchart of a network access handover method illustrated according to an exemplary embodiment.

FIG. 8 is a flowchart of a network access handover method illustrated according to an exemplary embodiment.

FIG. 9 is a schematic diagram of a PLMN list configuration in the embodiment illustrated in FIG. 8.

FIG. 10 is a schematic diagram of a handover process in the embodiment illustrated in FIG. 8.

FIG. 11 is a schematic diagram of another handover process in the embodiment illustrated in FIG. 8.

FIG. 12 is a schematic diagram of a path switch for a remote UE in the embodiment illustrated in FIG. 8.

FIG. 13 is a block diagram of a network access handover apparatus illustrated according to an exemplary embodiment.

FIG. 14 is a block diagram of a network access handover apparatus illustrated according to an exemplary embodiment.

FIG. 15 is a schematic structural diagram of a computer device provided in an embodiment of the disclosure.

### DETAILED DESCRIPTION

Exemplary implementations will be described in detail herein, and examples of these implementations are illustrated in the accompanying drawings. When the following elaborations relate to the accompanying drawings, unless otherwise stated, the same numerals in different accompanying drawings refer to the same or similar elements. The implementations described in the following exemplary implementations are not intended to represent all implementations consistent with the implementations of the disclosure. Instead, they are merely examples of methods and apparatuses consistent with some aspects of the disclosure as elaborated in the appended claims.

It should be noted that, “several” refers to one or more, and “multiple” refers to two or more. “and/or” describes an association relationship between associated objects, which means that there may be three relationships. For example, A and/or B can mean A alone, both A and B exist, and B alone. In addition, the character “/” herein generally indicates that the associated objects are in an “or” relationship.

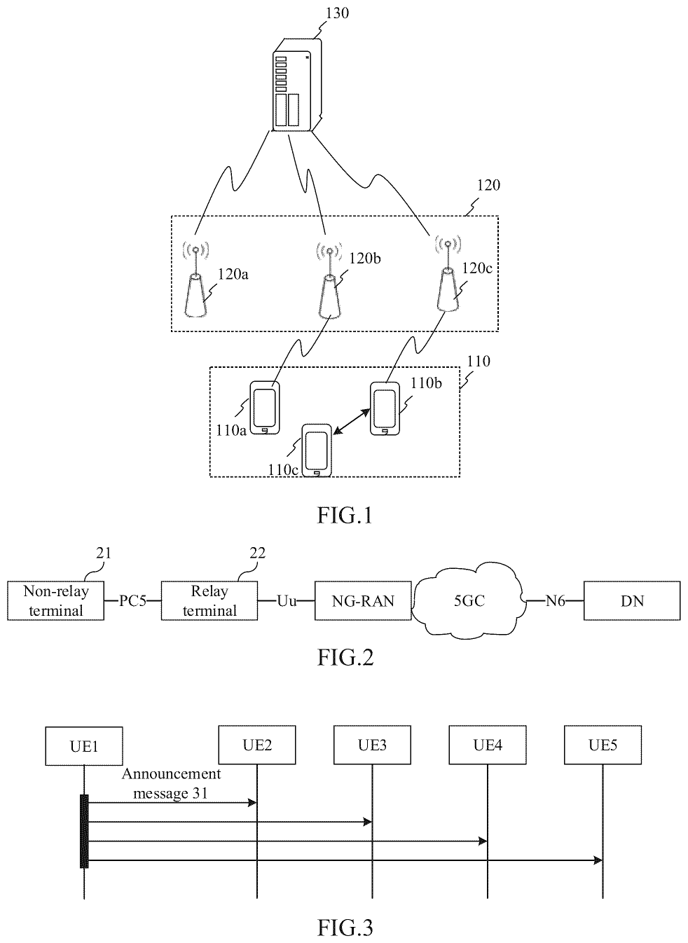

FIG. 1 is a schematic diagram of an implementation environment involved in a service access method illustrated in an exemplary embodiment of the disclosure. As illustrated in FIG. 1, the implementation environment may include a user equipment 110 and a base station 120.

The user equipment 110 includes a user equipment 110a, a user equipment 110b, and a user equipment 110c. The base station 120 includes a base station 120a, a base station 120b, and a base station 120c. The user equipment 110a accesses a network through the base station 120b. The user equipment 110b accesses the network through the base station 120c.

The user equipment 110 is a wireless communication device which supports multiple wireless access technologies for sidelink transmission. For example, the user equipment 110 may support cellular mobile communication technology such as a 5th generation mobile communication (5G) technology. Optionally, the user equipment 110 may also support a next-generation mobile communication technology of the 5G technology.

Sidelink transmission may be directly performed between two UEs 110. For example, as illustrated in above FIG. 1, sidelink transmission may be performed between the user equipment 110c and the user equipment 110b. Optionally, when sidelink transmission is performed between the user equipment 110c and the user equipment 110b in above FIG. 1, the user equipment 110b may serve as a relay to provide a network access service for the user equipment 110c, which is also referred to as a relay sidelink scenario.

FIG. 1 illustrates only an example of the implementation environment including three UEs and three base stations, and the number of UEs and base stations in the implementation environment are not limited in embodiments of the disclosure.

For example, the user equipment 110 may be an in-vehicle communication device, such as an electronic control unit with a wireless communication function or a wireless communication device externally connected to electronic control unit.

Optionally, the user equipment 110 may also be a roadside equipment, such as a road lamp, a signal lamp, or other roadside equipment with a wireless communication function.

Optionally, the user equipment 110 may also be a user terminal device, such as a mobile phone (or referred to as “cellular” phone) and a computer with a mobile terminal such as a portable, pocket-sized, hand-held, computer-built, or in-vehicle mobile device. For example, the user equipment 110 may be a station (STA), a subscriber unit, a subscriber station, a mobile station, a mobile, a remote station, an access point, a remote terminal, an access terminal, a user terminal, a user agent, a user device, or a user equipment (UE). For example, the user equipment 110 may be a mobile terminal such as a smart phone, a pad, or an e-book reader, or a smart wearable device such as smart glasses, a smart watch, or a smart band.

The base station 120 may be a network-side device in a wireless communication system, where the wireless communication system may be a 5G system, also referred to as a new radio (NR) system. Optionally, the wireless communication system may be a next-generation system of the 5G system.

The base station 120 may be a gNB with a centralized/distributed architecture in the 5G system. The base station 120 with the centralized/distributed architecture usually includes a centralized unit (CU) and at least two distributed units (DU). The centralized unit is configured with a protocol stack of a packet data convergence protocol (PDCP) layer, a radio link control (RLC) layer, and a media access control (MAC) layer. The distributed unit is configured with a physical (PHY) layer protocol stack. Embodiment s of the disclosure are not limited to a specific implementation of the base station 120.

The base station 120 and the user equipment 110 may establish a wireless connection via a wireless air-interface. The wireless air-interface is a wireless air-interface based on a 5G network technical standard, for example, a NR. Optionally, the wireless air-interface may be a wireless air-interface based on a next-generation mobile communication technical standard of the 5G.

Optionally, the wireless communication system may also include a network management device 130.

Several base stations 120 are respectively connected to the network management device 130. The network management device 130 may be a core network device in a wireless communication system. For example, the network management device 130 may include an access and mobility management function (AMF), a session management function (SMF), a user plane function (UPF), a policy control function (PCF), a unified data management (UDM), etc. Embodiments of the disclosure are not limited to an implementation form of the network management device 130.

With the continuous development of 5G applications, a network controlled interactive service (NCIS) is introduced into the standard as a new service form for related standardized services.

The NCIS is mainly targeted at applications such as augmented reality (AR)/virtual reality (VR), games, etc., which has high requirements for service quality such as rate, delay, loss tolerance, high-speed coding and so on. For example, for a VR game, a rate of 10 Gbps is required, and a loss tolerance should not exceed 1/10⁻⁴ (i.e., at most one packet loss is allowed for every 10000 packets). A session established for the NCIS is an NCIS session, and UEs in a same NCIS session may be considered as an NCIS group, for example, a team in a game.

In 3rd generation partnership project (3GPP) R17, a solution of proximity service communication is designed using a 5G proximity services (ProSe) project. ProSe includes NCIS. An important scenario in ProSe is a UE-to-Network (U2N) relay scenario. In U2N relay, a relay terminal (relay UE) relays transmission data for a non-relay terminal (also referred to as a remote terminal (remote UE)), so that the remote UE can communicate with the network.

FIG. 2 is a diagram of a U2N relay system architecture illustrated in an exemplary embodiment of the disclosure. As illustrated in FIG. 2, a PC5 interface-based connection (i.e., a PC5 connection) is established between a non-relay terminal 21 (remote UE) and a relay terminal 22 (relay UE) in a relay sidelink scenario. A Uu interface-based connection is established between the relay terminal 22 and a NG radio access network (NG-RAN) in a 5G network. A 5G core network in the 5G network is connected with a data network (DN) through a N6 interface-based connection.

As illustrated in FIG. 2, a PC5 link is established between the remote UE and the relay UE. The relay UE provides Layer 3 U2N relay service for the remote UE (i.e. an IP address of the remote UE is configured by the relay UE). The relay UE uses a packet data unit (PDU) session for the remote UE to relay data from or to the remote UE.

Each PDU session corresponds to a session type such as internet protocol version 4 (IPv4), internet protocol version 6 (IPv6), IPv4v6, Ethernet, Unstructured, etc. Data corresponding to a session type may be sent using a PDU session corresponding to the session type.

In order to implement relay communication, the relay and remote UEs require to obtain necessary configuration parameters before relay communication. These configuration parameters may come from a policy control function (PCF) or an application server, or may be pre-configured on a terminal or in a subscriber identity module (SIM) card.

In the system architecture illustrated in FIG. 2, the remote UE requires to discover a suitable relay UE and establish a PC5 connection with the relay UE before sending data.

Relay discovery may be achieved in a model A discovery procedure or a model B discovery procedure.

FIG. 3 is a schematic flowchart of a relay UE discovery procedure illustrated in an exemplary embodiment of the disclosure. As illustrated in FIG. 3, in the model A discovery procedure, a relay UE proactively broadcasts a relay service code (RSC) of a relay service that can be provided by the relay UE. After receiving the RSC, if the RSC is a required RSC of a remote UE, the remote UE determines that a suitable relay UE is discovered. For example, in FIG. 3, a relay UE (i.e., UE1) proactively sends an announcement message 31 containing a RSC for UE1 to each remote UE (i.e., UE2 to UE5). After receiving the announcement message 31, a certain UE of UE2 to UE5 takes the UE1 as a suitable UE when determining that the RSC in the announcement message 31 is a required RSC.

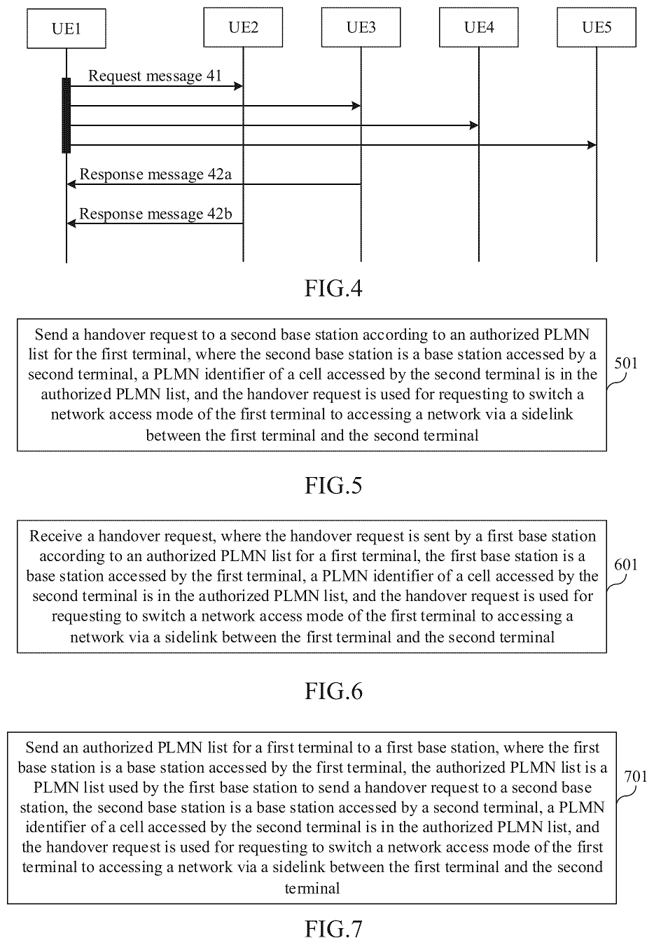

FIG. 4 is a schematic flowchart of another relay UE discovery procedure illustrated in an exemplary embodiment of the disclosure. As illustrated in FIG. 4, in the model B discovery procedure, a remote UE first sends out a required RSC, and if there is a relay UE which may support the RSC in proximity, the relay UE replies to the remote UE, and the remote UE determines that a suitable relay UE is discovered.

For example, in FIG. 4, a remote UE (i.e. UE1) sends a request message 41 containing a RSC required by UE1 to UEs (i.e. UE2 to UE5) in proximity. After receiving the request message 41, UE2 and UE3 respectively determine that they support the RSC, and reply to the UE1 with a response message 42a and a response message 42b respectively. Then UE1 takes UE2 and UE3 as suitable relay UEs.

After the discovery procedure illustrated in FIG. 3 or FIG. 4, a PC5 connection may be established between the relay UE and the remote UE.

In Release 17, an intra-gNB scenario where gNB remains unchanged before and after handover is considered for U2N relay handover scenario. However, intra-gNB also limits the U2N relay handover scenario. For example, when a remote UE moves out of the coverage of a current gNB, U2N relay handover cannot be performed directly.

To solve the above problem, subsequent embodiments of the disclosure provide a method for realizing U2N relay handover between different base stations, so that a remote UE may be directly switched to accessing the network via a relay UE corresponding to another gNB.

FIG. 5 is a flowchart of a network access handover method illustrated according to an exemplary embodiment. The network access handover method may be performed by a first base station. The first base station is a base station accessed by a first terminal. For example, the first base station may be the base station 120 in the implementation environment illustrated in FIG. 1. As illustrated in FIG. 5, the method may include the following operations.

At 501, a handover request is sent to a second base station according to an authorized PLMN list for the first terminal, where the second base station is a base station accessed by a second terminal, a PLMN identifier of a cell accessed by the second terminal is in the authorized PLMN list, and the handover request is used for requesting to switch a network access mode of the first terminal to accessing a network via a sidelink between the first terminal and the second terminal.

In summary, in the solution in embodiments of the disclosure, the first terminal has the corresponding authorized PLMN list. If the PLMN identifier of the cell accessed by the second terminal is in the authorized PLMN list, the base station accessed by the first terminal may send the handover request to the base station accessed by the second terminal, so that the network access mode of the first terminal may be switched to accessing a network via the sidelink between the first terminal and the second terminal. In the foregoing solution, the change of the accessed base station may be supported during the process of switching the network access mode of one terminal to accessing the network with the other terminal served as a relay, thereby extending a relay sidelink handover scenario and improving the efficiency of a terminal switching to accessing the network via another terminal.

FIG. 6 is a flowchart of a network access handover method illustrated according to an exemplary embodiment. The network access handover method may be performed by a second base station. The second base station is a base station accessed by a second terminal. For example, the second base station may be the base station 120 in the implementation environment illustrated in FIG. 1. As illustrated in FIG. 6, the method may include the following operations.

At 601, a handover request is received, where the handover request is sent by a first base station according to an authorized PLMN list for a first terminal, the first base station is a base station accessed by the first terminal, a PLMN identifier of a cell accessed by the second terminal is in the authorized PLMN list, and the handover request is used for requesting to switch a network access mode of the first terminal to accessing a network via a sidelink between the first terminal and the second terminal.

In summary, in a solution illustrated in embodiments of the disclosure, the first terminal has the corresponding authorized PLMN list. If the PLMN identifier of the cell accessed by the second terminal is in the authorized PLMN list, the base station accessed by the second terminal may send the handover request to the base station accessed by the first terminal, so that the network access mode of the first terminal may be switched to accessing a network via the sidelink between the first terminal and the second terminal. In the foregoing solution, the change of the accessed base station may be supported during the process of switching the network access mode of one terminal to accessing the network with the other terminal served as a relay, thereby extending a relay sidelink handover scenario and improving the efficiency of a terminal switching to accessing the network via another terminal.

In the embodiment of the disclosure illustrated in FIG. 5 or FIG. 6 above, a PLMN identifier of the first terminal may be provided by a core network device to the first base station accessed by the first terminal.

FIG. 7 is a flowchart of a network access handover method illustrated according to an exemplary embodiment. The network access handover method may be performed by a core network device. As illustrated in FIG. 7, the method may include the following operations.

At 701, an authorized PLMN list for a first terminal is sent to a first base station, where the first base station is a base station accessed by the first terminal, the authorized PLMN list is a PLMN list used by the first base station to send a handover request to a second base station, the second base station is a base station accessed by a second terminal, a PLMN identifier of a cell accessed by the second terminal is in the authorized PLMN list, and the handover request is used for requesting to switch a network access mode of the first terminal to accessing a network via a sidelink between the first terminal and the second terminal.

In summary, in a solution illustrated in embodiments of the disclosure, the core network device may provide an authorized PLMN list to the base station accessed by the first terminal. If the PLMN identifier of the cell accessed by the second terminal is in the authorized PLMN list, the base station accessed by the first terminal may send the handover request to the base station accessed by the second terminal, so that the network access mode of the first terminal may be switched to accessing a network via the sidelink between the first terminal and the second terminal. In the foregoing solution, the change of the accessed base station may be supported during the process of switching the network access mode of one terminal to accessing the network with the other terminal served as a relay, thereby extending a relay sidelink handover scenario and improving the efficiency of a terminal switching to accessing the network via another terminal.

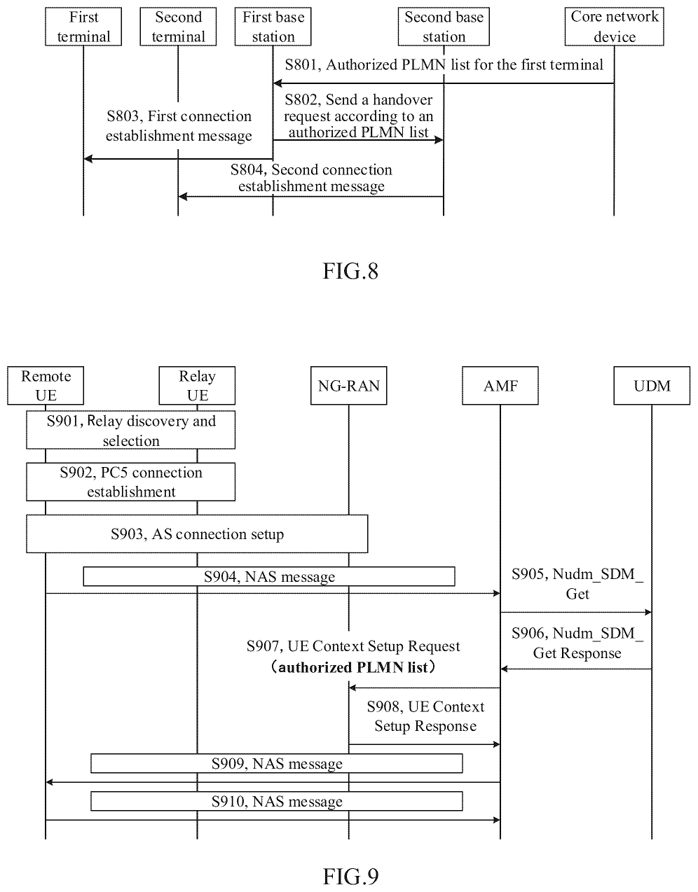

FIG. 8 is a flowchart of a network access handover method illustrated according to an exemplary embodiment. The network access handover method may be interactively performed by a first base station, a second base station, and a core network device in a relay sidelink scenario. For example, the first base station and the second base station each may be the base station 120 in the implementation environment illustrated in FIG. 1. As illustrated in FIG. 8, the method may include the following operations.

At 801, the core network device sends an authorized PLMN list for the first terminal to the first base station. Correspondingly, the first terminal receives the authorized PLMN list sent by the core network device.

The first base station may be a base station currently accessed by the first terminal.

In a possible implementation, the base station currently accessed by the first terminal may refer to a base station directly accessed by the first terminal, i.e., the first terminal accesses the network through a Uu interface between the first terminal and the first base station.

In another possible implementation, the base station currently accessed by the first terminal may also refer to the base station indirectly accessed by the first terminal. For example, a PC5 connection is established between the first terminal and a third terminal, a Uu interface-based connection is established between the third terminal and the first base station, and the first terminal accesses a network with the third terminal served as a relay (i.e., U2N relay scenario).

In a possible implementation, the core network device is an AMF, and the core network device sends the authorized PLMN list for the first terminal to the first base station as follows.

The AMF sends the authorized PLMN list to the first base station via an initial context establishment request. Correspondingly, the first base station receives the authorized PLMN list sent by the AMF via the initial context establishment request.

In a possible implementation, the authorization PLMN list is carried by ProSe authorization information in the initial context establishment request.

Optionally, the authorized PLMN list is carried by a movement restriction list in the initial context establishment request.

Optionally, the authorized PLMN list is carried by a separate information element in the initial context establishment request.

Refer to FIG. 9, which is a schematic diagram of a PLMN list configuration in embodiments of the disclosure. As illustrated in FIG. 9, an AMF configures a PLMN list to a source base station (i.e., a first base station) in U2N relay handover as follows.

S901, relay discovery and selection are performed between a remote UE and a relay UE.

S902, PC5 connection establishment is performed between the remote UE and the relay UE.

S903, with the relay UE as a relay, the remote UE performs an access stratum (AS) connection setup with the NG-RAN (corresponding to the first base station).

S904, with the relay UE as a relay, the remote UE sends a Non-AS (NAS) message to an AMF.

The NAS message may be a Registration Request message or a Service Request message.

S905, the AMF sends a Nudm_SDM_Get message to a UDM.

S906, the UDM returns a Nudm_SDM_Get Response message to the AMF.

S907, the AMF sends a UE Context Setup Request to the NG-RAN.

The UE context setup request contains an authorized PLMN list.

S908, the NG-RAN returns a UE Context Setup Response to the AMF.

S909, the AMF sends a NAS message to the remote UE.

The NAS message may be a Registration Accept message or a Service Accept message.

S910, with the relay UE as a relay, the remote UE sends a NAS message to the AMF.

The NAS message may be a Registration Complete message.

In another possible implementation, the first base station may also receive the authorized PLMN list sent by the AMF via a N2 path switch request acknowledgement.

In an exemplary solution of embodiments of the disclosure, the first terminal may handover from a third base station to the first base station prior to operation 801. The authorized PLMN list for the first terminal may sent by the AMF to the first base station via a N2 path switch request acknowledgement during the handover of the first terminal from the third base station to the first base station. Optionally, the authorized PLMN list for the first terminal may also be sent by the third base station to the first base station during the handover of the first terminal from the third base station to the first base station.

At 802, the first base station sends a handover request to a second base station according to an authorized PLMN list for the first terminal. Correspondingly, the second base station receives the handover request.

The second base station is a base station accessed by a second terminal. A PLMN identifier of a cell accessed by the second terminal is in the authorized PLMN list. The handover request is used for requesting to switch a network access mode of the first terminal to accessing a network via a sidelink between the first terminal and the second terminal.

In a possible implementation, before the first base station sends the handover request to the second base station according to the authorized PLMN list for the first terminal, the following may be performed.

Relay terminal information reported by the first terminal is received. The relay terminal information is used for indicating at least one candidate relay terminal discovered by the first terminal.

The handover request is sent to the second base station according to the authorized PLMN list for the first terminal as follows.

The second terminal is determined from the at least one candidate relay terminal according to the authorized PLMN list.

The handover request is sent to the second base station accessed by the second terminal.

In embodiments of the disclosure, the first terminal may report to the first base station information related to the candidate relay terminal(s) discovered by first terminal (i.e., the relay terminal information), which may include an identifier of the candidate relay terminal, a service cell identifier of the candidate relay terminal, etc. When the first base station determines that the first terminal requires handover, the first base station may determine the second terminal from the candidate relay terminal(s) discovered by the first terminal according to the authorized PLMN list for the first terminal.

For example, according to the authorized PLMN list for the first terminal, the first base station may select candidate relay terminals each with a serving cell identifier in the authorized PLMN list, and select, from the candidate relay terminals each with a serving cell identifier in the authorized PLMN list, a terminal with a signal strength between the terminal and the first terminal satisfies a switch condition (e.g., the signal strength is the highest, and is higher than a switch threshold) as the foregoing second terminal. The signal strength between the candidate relay terminal and the first terminal may be carried by the relay terminal information, or may be reported by the first terminal through other messages than the relay terminal information.

The candidate relay terminal may be a terminal satisfying a relay selection criterion of the first terminal. For example, the candidate relay terminal may be a relay terminal whose relay service code satisfies a requirement of the first terminal.

In a possible implementation, when the first terminal accesses the network in a direct-connection mode, before the first base station sends the handover request to the second base station according to the authorized PLMN list for the first terminal, the following may be performed.

The first base station receives first measurement information reported by the first terminal. The first measurement information is used for indicating a radio signal quality between the first terminal and the first base station.

The first base station sends the handover request to the second base station according to the authorized PLMN list for the first terminal as follows.

The first base station sends the handover request to the second base station according to the authorized PLMN list when the first measurement information satisfies a first switch condition.

In a possible implementation, the first switch condition includes that the radio signal quality between the first terminal and the first base station is lower than a first signal-quality threshold.

In embodiments of the disclosure, if the first terminal directly accesses the base station, the first terminal may further report the radio signal quality between the first terminal and the first base station to the first base station (e.g., the first terminal may report a Uu measurement result between the first terminal and the first base station). When the first base station determines that the radio signal quality between the first base station and the first terminal satisfies the switch condition, for example, the radio signal quality is lower than a certain radio signal quality threshold, sending of the handover request to the second base station according to the authorized PLMN list may be triggered.

In a possible implementation, when the first terminal accesses the network in an indirect-connection mode, before the first base station sends the handover request to the second base station according to the authorized PLMN list for the first terminal, the following may be performed.

The first base station receives second measurement information reported by the first terminal. The second measurement information is used for indicating a radio signal quality between the first terminal and a third terminal. A relay sidelink connection is established between the first terminal and the third terminal.

The first base station sends the handover request to the second base station according to the authorized PLMN list for the first terminal as follows.

The first base station sends the handover request to the second base station according to the authorized PLMN list when the second measurement information satisfies a second switch condition.

In a possible implementation, the second switch condition includes that the radio signal quality between the first terminal and the third terminal is lower than a second signal-quality threshold.

In embodiments of the disclosure, if the first terminal indirectly accesses the base station via the third terminal, the first terminal may further report the radio signal quality between the first terminal and the third terminal to the first base station (e.g., the first terminal may report a PC5 measurement result between the first terminal and the third terminal). When the first base station determines that the radio signal quality between the first terminal and the second terminal satisfies the switch condition, for example, the radio signal quality is lower than a certain radio signal quality threshold, sending of the handover request to the second base station according to the authorized PLMN list may be triggered.

In a possible implementation, the first base station may send the authorized PLMN list to the second base station. Correspondingly, the second base station may receive the authorized PLMN list sent by the first base station.

In embodiments of the disclosure, if the first base station determines to send the handover request to the second base station to request to switch the first terminal to accessing the network through the second terminal, the first base station may also provide the authorized PLMN list for the first terminal to the second base station, in order for the second base station to select a new target base station for U2N relay handover according to the authorized PLMN list when the second base station subsequently switches a data path for the first terminal again.

In a possible implementation, the first base station sends an authorized PLMN list to the second base station as follows.

The first base station may send the authorized PLMN list to the second base station during a preparation stage of switching the network access mode of the first terminal to accessing the network via the sidelink between the first terminal and the second terminal. Correspondingly, the second base station receives the authorized PLMN list sent by the first base station during the preparation stage of switching the network access mode of the first terminal to accessing the network via the sidelink between the first terminal and the second terminal.

In embodiments of the disclosure, if the first base station determines to send the handover request to the second base station to request to switch the first terminal to accessing the network through the second terminal, the first base station may send the authorized PLMN list for the first terminal to the second base station in a handover preparation stage.

In another possible implementation, the first base station sends the authorized PLMN list to the second base station as follows.

The first base station sends the authorized PLMN list to the second base station via a source to target transparent container. Correspondingly, the second base station receives the authorized PLMN list sent by the first base station via the source to target transparent container.

In embodiments of the disclosure, if the first base station determines to send the handover request to the second base station to request to switch the first terminal to accessing the network through the second terminal, the first terminal may send the authorized PLMN list for the first terminal to the second base station via the source to target transparent container.

In a possible implementation, the core network device may send the authorized PLMN list to the second base station. Correspondingly, the second base station receives the authorized PLMN list sent by the core network device.

In embodiments of the disclosure, the foregoing process of providing the authorized PLMN list for the first terminal to the second base station may also be performed by the core network device.

In a possible implementation, the second base station may receive the authorized PLMN list for the first terminal sent by the AMF.

In a possible implementation, the core network device may be a source AMF corresponding to the first base station. The core network device sends the authorized PLMN list to the second base station as follows.

The source AMF corresponding to the first base station sends the authorized PLMN list to a target AMF corresponding to the second base station, so that the target AMF sends the authorized PLMN list to the second base station. Correspondingly, the second base station receives the authorized PLMN list for the target AMF corresponding to the second base station. The authorized PLMN list is sent, by the source AMF corresponding to the first base station, to the target AMF.

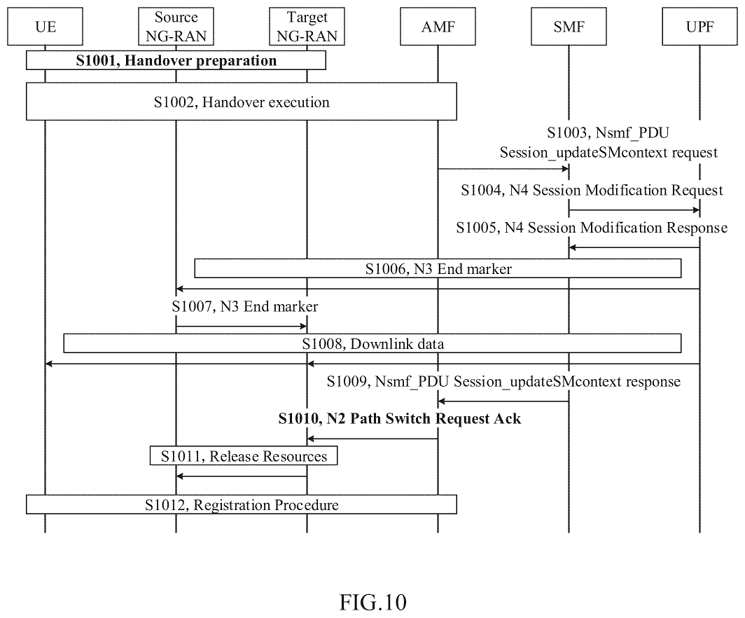

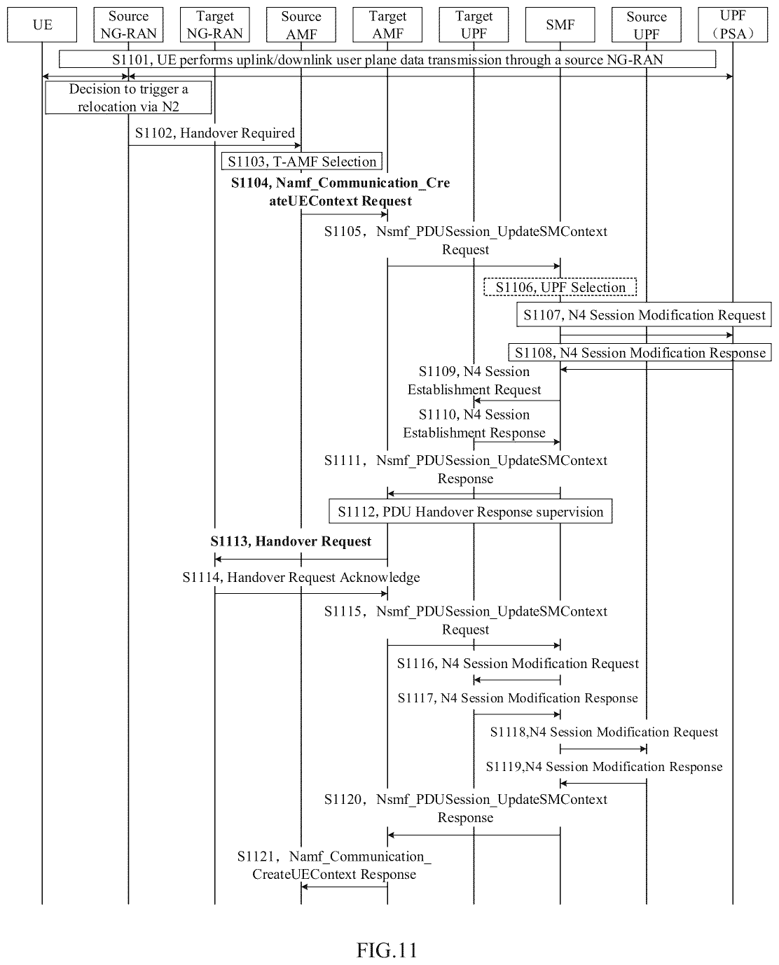

Refer to FIG. 10, which is a schematic diagram of a handover process according to embodiments of the disclosure. As illustrated in FIG. 10, the handover process is as follows.

S1001, handover preparation is performed among a UE (i.e., first terminal), a source NG-RAN (i.e., first base station), and a target NG-RAN (i.e., second base station).

S1002, handover execution is performed among the UE, the source NG-RAN, and the target NG-RAN.

In this operation, the source NG-RAN executes data forwarding to the target NG-RAN, and sends a radio access network (RAN) Usage data report to an AMF. The target NG-RAN sends an N2 Path Switch Request to the AMF.

S1003, the AMF sends an Nsmf_PDUSession_UpdateSMContext Request to a SMF.

S1004, the SMF sends an N4 Session Modification Request to a UPF.

S1005, the UPF sends an N4 Session Modification Response to the SMF.

S1006, the UPF sends an N3 End marker to the source NG-RAN.

S1007, the source NG-RAN sends an N3 end marker to the target NG-RAN.

S1008, the UPF sends Downlink data to the UE via the target NG-RAN.

S1009, the SMF sends an Nsmf_PDUSession_UpdatSMContext response to the AMF.

S1010, the AMF sends an N2 Path Switch Request Ack to the target NG-RAN.

S1011, the target NG-RAN sends a Release Resources message to the source NG-RAN.

S1012, a registration procedure is executed between the UE and the AMF.

In the solution illustrated in FIG. 10 above, the source NG-RAN (i.e., the first base station, also referred to as the source gNB) sends an authorized PLMN list for UE (authorized PLMN ID list for remote UE) to the target NG-RAN (i.e., the second base station, also referred to as the target gNB) in the handover preparation stage. Optionally, the AMF sends the authorized PLMN ID list for remote UE to the target gNB at S1010.

Refer to FIG. 11, which is a schematic diagram of another handover process according embodiments of the disclosure. As illustrated in FIG. 11, the handover process is as follows.

S1101, a UE performs uplink/downlink user plane data transmission through a source NG-RAN.

S1102, when a decision to trigger a relocation via N2 is made, the source NG-RAN sends a Handover Required to a source AMF.

S1103, the source AMF selects a target AMF (i.e., T-AMF Selection).

S1104, the source AMF sends a Namf_Communication_CreateUEContext Request to a target AMF.

S1105, the target AMF sends an Nsmf_PDUSession_UpdateSMContext Request to a SMF.

S1106, the SMF selects a UPF (i.e., UPF Selection).

S1107, the SMF sends an N4 Session Modification Request to a PSA UPF.

S1108, the PSA UPF sends an N4 Session Modification Response to the SMF.

S1109, the SMF sends an N4 Session Establishment Request to a target UPF.

S1110, the target UPF sends an N4 Session Establishment Response to the SMF.

S1111, the SMF sends an Nsmf_PDUSession_UpdateSMContext Response to the target AMF.

S1112, PDU Handover Response supervision is performed between the target AMF and the SMF.

S1113, the target AMF sends a Handover Request to the target NG-RAN.

S1114, the target NG-RAN sends a handover request acknowledgement (Handover Request Acknowledge) to the target AMF.

S1115, the target AMF sends an Nsmf_PDUSession_UpdateSMContext Request to the SMF.

S1116, the SMF sends an N4 Session Modification Request to the target UPF.

S1117, the target UPF sends an N4 Session Modification Response to the SMF.

S1118, the SMF sends the N4 Session Modification Request to the source UPF.

S1119, the source UPF sends the N4 Session Modification Response to the SMF.

S1120, the SMF sends an Nsmf_PDUSession_UpdateSMContext Response to the target AMF.

S1121, the target AMF sends an Namf_Communication_CreateUEContext Response to the source AMF.

In the solution illustrated in FIG. 11 above, the source gNB sends an authorized PLMN ID list for remote UE to the target gNB via a source to target transparent container. Optionally, the source AMF sends the authorized PLMN ID list for remote UE to the target AMF at S1104, and then the target AMF sends the authorized PLMN ID list for remote UE to the target gNB at S1113.

Optionally, after the handover (HO) ends and the AMF obtains subscriber data of the UE, the AMF sends the authorized PLMN ID list for remote UE to the target gNB.

At 803, the first base station sends a first connection establishment message to the first terminal. The first connection establishment message is used for indicating the first terminal to establish a sidelink connection with the second terminal.

At 804, the second base station sends a second connection establishment message to the second terminal. The second connection establishment message is used for indicating the second terminal to establish a sidelink connection with the first terminal.

When the first terminal receives the first connection establishment message and the second terminal receives the second connection establishment message, a PC5 connection may be established between the first terminal and the second terminal, and the first terminal accesses the network with the second terminal as a relay.

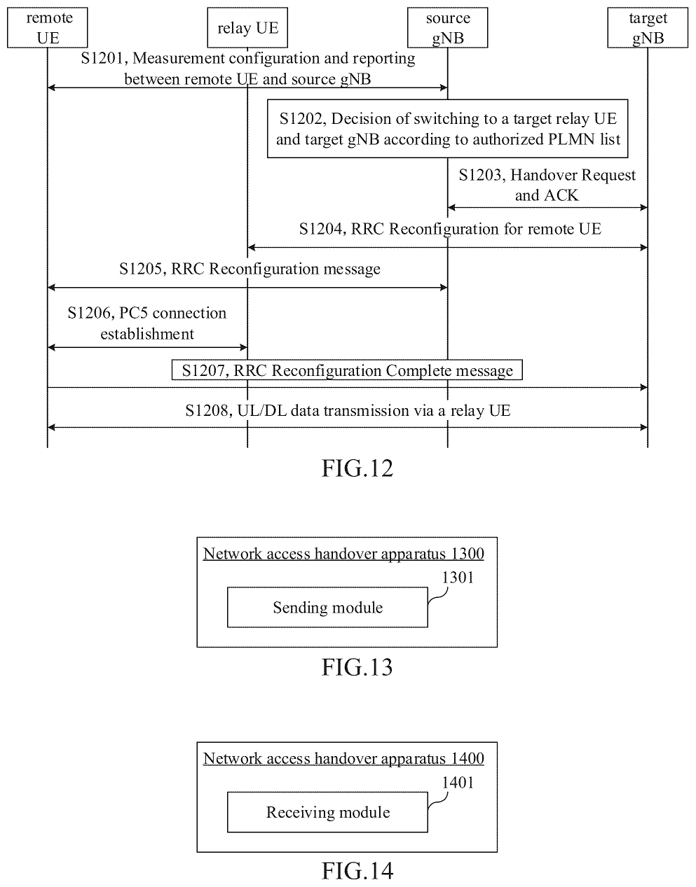

Refer to FIG. 12, which is a schematic diagram of a path switch for a remote UE according to embodiments of the disclosure. As illustrated in FIG. 12, taking the path switch from a direct-connection mode to an indirect-connection mode as an example, the process may be as follows.

S1201, the remote UE and a source gNB perform measurement configuration and reporting.

A U2N remote UE reports a candidate U2N relay UE and Uu measurement data.
1) The relay reported by UE requires to satisfy a relay selection criterion, for example, a relay service code satisfies the requirement.
2) The report includes at least a U2N relay UE ID and a serving cell ID of the U2N relay UE.

S1202, the source gNB decides to switch the remote UE to a target relay UE and a target gNB according to the authorized PLMN list for the remote UE.

The source gNB decides to initiate switching the U2N remote UE to a target U2N relay UE. The gNB selects a suitable relay according to an authorized PLMN ID list. When a PLMN ID corresponding to the serving cell ID of the U2N relay UE is in the authorized PLMN ID list, the relay may be selected.

S1203, handover request and acknowledgement (ACK) is performed between the source gNB and the target gNB.

The source gNB initiates a handover request message to the target gNB. The message may be sent directly to the target gNB or forwarded to the target gNB through a core network.

S1204, RRC reconfiguration for the remote UE is performed between the relay UE and the target gNB.

The target gNB may send an RRC reconfiguration message to the target U2N relay UE.

S1205, the source gNB sends the RRC reconfiguration message to the remote UE.

The source gNB sends the RRC reconfiguration message to the U2N remote UE.

S1206, if there is no PC5 connection between the remote UE and the relay UE, PC5 connection establishment is performed between the remote UE and the relay UE.

The U2N Remote UE establishes a PC5 connection with the target U2N relay UE.

S1207, the remote UE sends an RRC reconfiguration complete message to the target gNB through the relay UE.

The U2N remote UE completes the path switch, and sends the RRC reconfiguration complete message to the gNB through the relay UE. Thus, the data path between the remote UE and the gNB is switched from the direct-connection mode to the indirect-connection mode.

S1208, uplink/downlink (UL/DL) data transmission is performed between the remote UE and the target gNB through the relay UE.

For a path switch from an indirect-connection mode to an indirect-connection mode, the gNB selects a relay UE by using authorized PLMN ID list in a manner similar to the solution illustrated in FIG. 12 above, which will not be repeated here.

The following are apparatus embodiments of the disclosure, where the apparatuses may be configured to perform the method embodiments of the disclosure. For details not disclosed in the apparatus embodiments of the disclosure, refer to the method embodiments of the disclosure.

FIG. 13 is a block diagram of a network access handover apparatus 1300 illustrated according to an exemplary embodiment.

The apparatus illustrated in FIG. 13 above may perform all or some of the operations performed by a first base station in any of the embodiments of FIGS. 5, 6, 7 and 8. The first base station is a base station accessed by a first terminal. The apparatus may include a sending module 1301.

The sending module 1301 is configured to send a handover request to a second base station according to an authorized PLMN list for the first terminal, where the second base station is a base station accessed by a second terminal, a PLMN identifier of a cell accessed by the second terminal is in the authorized PLMN list, and the handover request is used for requesting to switch a network access mode of the first terminal to accessing a network via a sidelink between the first terminal and the second terminal.

In a possible implementation, the apparatus further includes a receiving module.

The receiving module is configured to receive relay terminal information reported by the first terminal before the sending module sends the handover request to the second base station according to the authorized PLMN list for the first terminal, where the relay terminal information is used for indicating at least one candidate relay terminal discovered by the first terminal.

The sending module 1301 is configured to determine the second terminal from the at least one candidate relay terminal according to the authorized PLMN list, and to send the handover request to the second base station accessed by the second terminal.

In a possible implementation, the apparatus further includes a receiving module.

The receiving module is configured to receive, when the first terminal accesses the network in a direct-connection mode and before the sending module sends the handover request to the second base station according to the authorized PLMN list for the first terminal, first measurement information reported by the first terminal, where the first measurement information is used for indicating radio signal quality between the first terminal and the first base station.

The sending module 1301 is configured to send the handover request to the second base station according to the authorized PLMN list when the first measurement information satisfies a first switch condition.

In a possible implementation, the first switch condition includes that the radio signal quality between the first terminal and the first base station is lower than a first signal-quality threshold.

In a possible implementation, the apparatus further includes a receiving module.

The receiving module is configured to receive, when the network is accessed by the first terminal in an indirect-connection mode and before the sending module sends the handover request to the second base station according to the authorized PLMN list for the first terminal, second measurement information reported by the first terminal, where the second measurement information is used for indicating radio signal quality between the first terminal and a third terminal, and a relay sidelink connection is established between the first terminal and the third terminal.

The sending module 1301 is configured to send the handover request to the second base station according to the authorized PLMN list when the second measurement information satisfies a second switch condition.

In a possible implementation, the second switch condition includes that the radio signal quality between the first terminal and the third terminal is lower than a second signal-quality threshold.

In a possible implementation, the sending module 1301 is further configured to send a first connection establishment message to the first terminal, where the first connection establishment message is used for indicating the first terminal to establish a sidelink connection with the second terminal.

In a possible implementation, the apparatus further includes a receiving module.

The receiving module is configured to receive the authorized PLMN list sent by a core network device before the sending module sends the handover request to the second base station according to the authorized PLMN list for the first terminal.

In a possible implementation, the receiving module is configured to receive the authorized PLMN list sent by an AMF via an initial context establishment request.

Optionally, the receiving module is configured to receive the authorized PLMN list sent by an AMF via a N2 path switch request acknowledgement.

In a possible implementation, the authorized PLMN list is carried by proximity service (ProSe) authorization information in the initial context establishment request.

Optionally, the authorized PLMN list is carried by a mobility restriction list in the initial context establishment request.

Optionally, the authorized PLMN list is carried by a separate information element in the initial context establishment request.

In a possible implementation, the sending module 1301 is further configured to send the authorized PLMN list to the second base station.

In a possible implementation, the sending module 1301 is configured to send the authorized PLMN list to the second base station during a preparation stage of switching the network access mode of the first terminal to accessing the network via the sidelink between the first terminal and the second terminal.

In a possible implementation, the sending module 1301 is configured to send the authorized PLMN list to the second base station via a source to target transparent container.

The apparatus illustrated in FIG. 13 above may perform all or some of the operations performed by the core network device in the embodiment of FIG. 7 or FIG. 8. The apparatus may include a sending module.

The sending module 1301 is configured to send an authorized PLMN list for a first terminal to a first base station, where the first base station is a base station accessed by the first terminal, the authorized PLMN list is a PLMN list used by the first base station to send a handover request to a second base station, the second base station is a base station accessed by a second terminal, a PLMN identifier of a cell accessed by the second terminal is in the authorized PLMN list, and the handover request is used for requesting to switch a network access mode of the first terminal to accessing network via a sidelink between the first terminal and the second terminal.

In a possible implementation, the core network device is an AMF, and the sending module 1301 is configured to send the authorized PLMN list to the first base station via an initial context establishment request.

In a possible implementation, the authorized PLMN list is carried by proximity service (ProSe) authorization information in the initial context establishment request.

Optionally, the authorized PLMN list is carried by a mobility restriction list in the initial context establishment request.

Optionally, the authorized PLMN list is carried by a separate information element in the initial context establishment request.

In a possible implementation, the sending module 1301 is further configured to send the authorized PLMN list to the second base station.

In a possible implementation, the apparatus is applied to a core network device, and the core network device is a source AMF corresponding to the first base station.

The sending module 1301 is configured to send the authorized PLMN list to a target AMF corresponding to the second base station, for the target AMF to send the authorized PLMN list to the second base station.

FIG. 14 is a block diagram of a network access handover apparatus 1400 illustrated according to an exemplary embodiment.

The apparatus illustrated in FIG. 14 above may perform all or some of the operations performed by the second base station in any of embodiments of FIGS. 5, 6, 7 and 8. The second base station is a base station accessed by a second terminal. The apparatus may include the following.

The receiving module 1401 is configured to receive a handover request sent by a first base station according to an authorized PLMN list for a first terminal, where the first base station is a base station accessed by the first terminal, a PLMN identifier of a cell accessed by the second terminal is in the authorized PLMN list, and the handover request is used for requesting to switch a network access mode of the first terminal to accessing the network via a sidelink between the first terminal and the second terminal.

In a possible implementation, the apparatus further includes a sending module.

The sending module is configured to send a second connection establishment message to the second terminal, where the second connection establishment message is used for indicating the second terminal to establish a sidelink connection with the first terminal.

In a possible implementation, the receiving module 1401 is further configured to receive the authorized PLMN list sent by the first base station.

In a possible implementation, the receiving module 1401 is configured to receive the authorized PLMN list sent by the first base station during a preparation stage of switching the network access mode of the first terminal to accessing the network via the sidelink between the first terminal and the second terminal.

In a possible implementation, the receiving module 1401 is configured to receive the authorized PLMN list sent by the first base station via a source to target transparent container.

In a possible implementation, the receiving module 1401 is further configured to receive the authorized PLMN list sent by a core network device.

In a possible implementation, the receiving module 1401 is configured to receive the authorized PLMN list sent by an AMF.

In a possible implementation, the receiving module 1401 is configured to receive the authorized PLMN list from a target AMF corresponding to the second base station, where the authorized PLMN list is sent to the target AMF by the source AMF corresponding to the first base station.

It should be noted that, when the apparatus provided in the foregoing embodiments implements its functions, the division into the above functional modules is only taken as an example for illustration. In practice, the above functions can be allocated to different functional modules according to actual needs, that is, the structure of the device is divided into different functional modules to complete all or some of the functions described above.

Regarding the apparatus in the foregoing embodiments, the manner in which each module performs operations has been described in detail in the related method embodiments and thus will not be elaborated again herein.

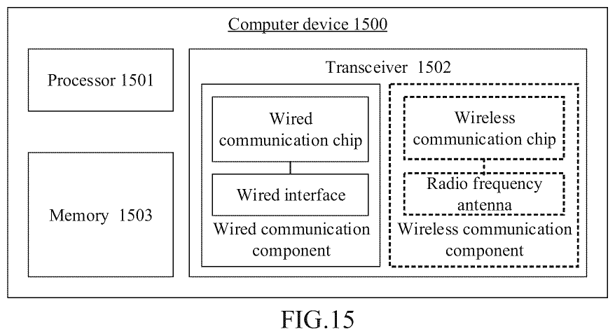

FIG. 15 is a schematic structural diagram of a computer device 1500 provided in an embodiment of the disclosure. The computer device 1500 may include a processor 1501 a transceiver 1502, and a memory 1503.

The processor 1501 includes one or more processing cores, and the processor 1501 executes various function applications and information processing by running software programs and modules.

The transceiver 1502 may include a receiver and a transmitter. For example, the transceiver 1502 may include a wired communication component which may include a wired communication chip and a wired interface (e.g., optical fiber interface). Optionally, the transceiver 1502 may also include a wireless communication component which may include a wireless communication chip and a radio frequency antenna.

The memory 1503 may be coupled to the processor 1501 and the transceiver 1502.

The memory 1503 may be configured to store a computer program. The processor 1501 is configured to execute the computer program to implement various operations executed by the base station or the core network device in the foregoing method embodiments.

In addition, the memory 1503 may be implemented by any type of transitory storage device or non-transitory storage device or a combination thereof. The transitory storage device or non-transitory storage device includes, but is not limited to, a magnetic disk or an optical disk, an electrically erasable programmable read-only memory, an erasable programmable read-only memory, a static random-access memory, a read-only memory, a magnetic memory, a flash memory, and a programmable read-only memory.

In an exemplary solution, when the computer device 1500 is implemented as a first base station accessed by a first terminal, the transceiver 1502 is configured to send a handover request to a second base station according to an authorized PLMN list for the first terminal, where the second base station is a base station accessed by a second terminal, a PLMN identifier of a cell accessed by the second terminal is in the authorized PLMN list, and the handover request is used for requesting to switch a network access mode of the first terminal to accessing a network via a sidelink between the first terminal and the second terminal.

The procedure performed by the transceiver 1502 in the computer device 1500 may refer to the operations performed by the first base station in methods illustrated in any of the foregoing FIGS. 5, 6, 7 and 8.

In an exemplary solution, when the computer device 1500 is implemented as a second base station accessed by a second terminal, the transceiver 1502 is configured to receive a handover request sent by a first base station according to an authorized PLMN list for a first terminal, where the first base station is a base station accessed by the first terminal, a PLMN identifier of a cell accessed by the second terminal is in the authorized PLMN list, and the handover request is used for requesting to switch a network access mode of the first terminal to accessing the network via a sidelink between the first terminal and the second terminal.

The procedure performed by the transceiver 1502 in the computer device 1500 may refer to the operations performed by the second base station in methods illustrated in any of the foregoing FIGS. 5, 6, 7 and 8.

In an exemplary solution, when the computer device 1500 is implemented as a core network device, the transceiver 1502 is configured to send an authorized PLMN list for a first terminal to a first base station, where the first base station is a base station accessed by the first terminal, the authorized PLMN list is a PLMN list used by the first base station to send a handover request to a second base station, the second base station is a base station accessed by a second terminal, a PLMN identifier of a cell accessed by the second terminal is in the authorized PLMN list, and the handover request is used for requesting to switch a network access mode of the first terminal to accessing network via a sidelink between the first terminal and the second terminal.

The procedure performed by the transceiver 1502 in the computer device 1500 may refer to the operations performed by the core network device in the method illustrated in any of the foregoing FIGS. 7 and 8.

Embodiments of the disclosure further provide a computer-readable storage medium. The storage medium is configured to store a computer program, and the computer program is loaded and executed by a processor to implement various operations executed by the first base station, the second base station, or the core network device in the method illustrated in any of the foregoing FIGS. 5, 6, 7 and 8.

The disclosure further provides a computer program product. The computer program product includes computer instructions. The computer instructions are stored in a computer-readable storage medium and are readable from the computer-readable storage medium and executable by a processor of a computer device, to implement various operations executed by the first base station, the second base station, or the core network device in the method illustrated in any of the foregoing FIGS. 5, 6, 7 and 8.

The disclosure further provides a chip. The chip is configured to be run in a computer device, to cause the computer device to implement various operations executed by the first base station, the second base station, or the core network device in the method illustrated in any of the foregoing FIGS. 5, 6, 7 and 8.

The disclosure further provides a computer program. The computer program is executed by a processor of a computer device, to implement various operations executed by the first base station, the second base station, or the core network device in the method illustrated in any of the foregoing FIGS. 5, 6, 7 and 8.

Those skilled in the art can appreciate that in one or more of the above examples, the functions described in the embodiments of the disclosure may be implemented by hardware, software, firmware, or any combination thereof. When implemented by software, the functions may be stored in a computer-readable medium or transmitted as one or more instructions or codes in the computer-readable medium. The computer-readable medium includes a computer storage medium and a communication medium, where the communication medium includes any medium that facilitates transfer of a computer program from one place to another, and the storage medium may be any available medium that can be accessed by a general-purpose computer or a special-purpose computer.

The foregoing elaborations are merely exemplary embodiments of the disclosure, and are not intended for limiting the disclosure. Any modification, equivalent replacement, and improvement made within the concept and principle of the disclosure shall fall within the protection scope of the disclosure.

What is claimed is:

1. A base station, being a first base station accessed by a first terminal and comprising:
a transceiver;
a memory configured to store a computer program; and
a processor coupled to the transceiver and the memory, wherein when executed by the processor, the computer program causes the first base station to:
send a handover request to a second base station according to an authorized public land mobile network (PLMN) list for the first terminal, wherein the second base station is a base station accessed by a second terminal, a PLMN identifier of a cell accessed by the second terminal is in the authorized PLMN list, and the handover request is used for requesting to switch a network access mode of the first terminal to accessing a network via a sidelink between the first terminal and the second terminal.

2. The first base station of claim 1, wherein the computer program further causes the first base station to:
before sending the handover request to the second base station according to the authorized PLMN list for the first terminal,
receive relay terminal information reported by the first terminal, wherein the relay terminal information is used for indicating at least one candidate relay terminal discovered by the first terminal; and
the computer program causing the first base station to send the handover request to the second base station according to the authorized PLMN list for the first terminal causes the first base station to:
determine the second terminal from the at least one candidate relay terminal according to the authorized PLMN list; and
send the handover request to the second base station accessed by the second terminal.

3. The first base station of claim 1, wherein:
when the first terminal accesses the network in a direct-connection mode, the computer program further causes the first base station to: before sending the handover request to the second base station according to the authorized PLMN list for the first terminal,
receive first measurement information reported by the first terminal, wherein the first measurement information is used for indicating a radio signal quality between the first terminal and the first base station; and
the computer program causing the first base station to send the handover request to the second base station according to the authorized PLMN list for the first terminal causes the first base station to:
send the handover request to the second base station according to the authorized PLMN list when the first measurement information satisfies a first switch condition.

4. The first base station of claim 3, wherein the first switch condition comprises that:
the radio signal quality between the first terminal and the first base station is lower than a first signal-quality threshold.

5. The first base station of claim 1, wherein:
when the first terminal accesses the network in an indirect-connection mode, the computer program further causes the first base station to: before sending the handover request to the second base station according to the authorized PLMN list for the first terminal,
receive second measurement information reported by the first terminal, wherein the second measurement information is used for indicating a radio signal quality between the first terminal and a third terminal, and a relay sidelink connection is established between the first terminal and the third terminal; and
the computer program causing the first base station to send the handover request to the second base station according to the authorized PLMN list for the first terminal causes the first base station to:
send the handover request to the second base station according to the authorized PLMN list when the second measurement information satisfies a second switch condition.

6. The first base station of claim 1, wherein the computer program further causes the first base station to:
send a first connection establishment message to the first terminal, wherein the first connection establishment message is used for indicating the first terminal to establish a sidelink connection with the second terminal.

7. The first base station of claim 1, wherein the computer program further causes the first base station to: before sending the handover request to the second base station according to the authorized PLMN list for the first terminal,
receive the authorized PLMN list sent by a core network device.

8. The first base station of claim 7, wherein the computer program causing the first base station to receive the authorized PLMN list sent by the core network device causes the first base station to:
receive the authorized PLMN list sent by an access and mobility management function (AMF) via an initial context establishment request; or
receive the authorized PLMN list sent by the AMF via a N2 path switch request acknowledgement.

9. The first base station of claim 8, wherein:
the authorized PLMN list is carried by proximity service (ProSe) authorization information in the initial context establishment request; or
the authorized PLMN list is carried by a mobility restriction list in the initial context establishment request; or
the authorized PLMN list is carried by a separate information element in the initial context establishment request.

10. The first base station of claim 1, wherein the computer program further causes the first base station to:
send the authorized PLMN list to the second base station.

11. The first base station of claim 10, wherein the computer program causing the first base station to send the authorized PLMN list to the second base station causes the first base station to:
send the authorized PLMN list to the second base station during a preparation stage of handovering the network access mode of the first terminal to accessing the network via the sidelink between the first terminal and the second terminal.

12. The first base station of claim 10, wherein the computer program causing the first base station to send the authorized PLMN list to the second base station causes the first base station to:
send the authorized PLMN list to the second base station via a source to target transparent container.

13. A base station, being a second base station accessed by a second terminal and comprising:
a transceiver;
a memory configured to store a computer program; and
a processor coupled to the transceiver and the memory, wherein when executed by the processor, the computer program causes the second base station to:
receive a handover request sent by a first base station according to an authorized public land mobile network (PLMN) list for a first terminal, wherein the first base station is a base station accessed by the first terminal, a PLMN identifier of a cell accessed by the second terminal is in the authorized PLMN list, and the handover request is used for requesting to switch a network access mode of the first terminal to accessing a network via a sidelink between the first terminal and the second terminal.

14. The second base station of claim 13, wherein the computer program further causes the second base station to:
send a second connection establishment message to the second terminal, wherein the second connection establishment message is used for indicating the second terminal to establish a sidelink connection with the first terminal.

15. The second base station of claim 13, wherein the computer program further causes the second base station to:
receive the authorized PLMN list sent by the first base station; or
receive the authorized PLMN list sent by an access and mobility management function (AMF).

16. The second base station of claim 15, wherein the computer program causing the second base station to receive the authorized PLMN list sent by the first base station causes the second base station to:
receive the authorized PLMN list sent by the first base station during a preparation stage of handovering the network access mode of the first terminal to accessing the network via the sidelink between the first terminal and the second terminal.

17. A core network device, comprising:
a transceiver;
a memory configured to store a computer program; and
a processor coupled to the transceiver and the memory, wherein when executed by the processor, the computer program causes the core network device to:
send an authorized public land mobile network (PLMN) list for a first terminal to a first base station, wherein the first base station is a base station accessed by the first terminal, the authorized PLMN list is a PLMN list used by the first base station to send a handover request to a second base station, the second base station is a base station accessed by a second terminal, a PLMN identifier of a cell accessed by the second terminal is in the authorized PLMN list, and the handover request is used for requesting to switch a network access mode of the first terminal to accessing a network via a sidelink between the first terminal and the second terminal.

18. The core network device of claim 17, wherein the core network device is an access and mobility management function (AMF), and the computer program causing the core network device to send the authorized PLMN list for the first terminal to the first base station causes the core network device to:
send the authorized PLMN list to the first base station via an initial context establishment request.

19. The core network device of claim 18, wherein:
the authorized PLMN list is carried by proximity service (ProSe) authorization information in the initial context establishment request; or
the authorized PLMN list is carried by a mobility restriction list in the initial context establishment request; or
the authorized PLMN list is carried by a separate information element in the initial context establishment request.

20. The core network device of claim 17, wherein the computer program further causes the core network device to:
send the authorized PLMN list to the second base station.
